(19) United States
(12) Patent Application Publication
(10) Pub. No.: US 2007/0045364 A1
(43) Pub. Date: Mar. 1, 2007

(54) Baton holder

(75) Inventors: Gary M. Grundy, South Milwaukee, WI (US); Jacqueline M. Dunstan, South Milwaukee, WI (US)

Correspondence Address: FOLEY & LARDNER LLP, 777 EAST WISCONSIN AVENUE, MILWAUKEE, WI, 53202-5306, US

(73) Assignee: Armament Leather, Inc.

(21) Appl. No.: 11/215,286

(22) Filed: Aug. 30, 2005

(51) Int. Cl. A01K 97/04; A45F 3/14

(52) U.S. Cl. 224/197; 224/666; 224/674; 224/914; 224/250

(57) ABSTRACT

A baton holster comprising a first holder configured to removably attach to a user and to receive a first portion of a baton for storage and a second holder coupled to the first holder and configured to receive a second portion of the baton for storage. The second holder may comprise a retaining flap having a first fastener member that is configured to engage a second fastener member provided on the first holder to affix the second holder in a closed position to support the baton when provided on the second holder. The first fastener member of the retaining flap may be configured to disengage the second fastener member provided on the first holder to provide the second holder in an open configuration so that a baton may be provided in an extended configuration to extend through the second holder.

### FIELD

The present invention generally relates to baton holders. In particular, the present invention relates to a baton holder for holding expandable batons.

### BACKGROUND

Many different types of holders are used as carrying cases for batons or other law enforcement or military equipment. A variety of known holders are made of leather or a like material and are often in the form of a circular pocket. Holders are generally attached to the waist, leg or shoulder portions of the body of the user by means of a belt, strap or harness. Oftentimes, a holder is provided with a closure strap or flap that prevents the baton from being broken out until the closure strap has been released. Such closure straps or flaps are typically provided to prevent unintentional dislodgement of the baton from the holder.

While “break out” baton holders have generally been known and used for standard, fixed length batons, the use of such holders for expandable batons has been limited due to the unique characteristics of expandable batons. For example, the handle on some expandable batons do not include a “stopper,” or other change in baton diameter, used on full length batons to prevent the baton from falling through the holder. Also, the problem of falling through prior holders is exacerbated by the fact that expandable batons are much shorter, when retracted, than full length batons, and smaller in diameter. Further, the handles of expandable batons are usually padded to provide a secure grip. Holders which rely solely on friction, or “pinching” the baton shaft typically do not securely retain such padded handles without excessive force, and may damage the handle padding.

A common known carrier used for expandable batons is a simple accessory case, e.g., a “pocket” type carrier usually made of leather and attachable to a wearer's belt. While the accessory case type carriers are acceptable in many applications, other applications present requirements which render accessory cases unsuitable. For example, it is sometimes required to draw the expandable baton laterally, and sometimes necessary to stow the baton in the extended position. Further, many known accessory cases do not prevent the expandable portion of batons from expanding unintentionally.

In view of these problems, it would be desirable to provide a baton holder that is configured to fit on a belt for stowing and allowing lateral break out of an expandable baton in either the retracted or extended positions. It would further be desirable to provide a holder that prevents the expandable portion of batons from expanding unintentionally. It would further be advantageous to provide a holder that comprises a retaining flap configured for easy removal and stowing of batons. It would further be desirable to provide a holder that minimizes the risk of unintentional removal of the baton. It would further be advantageous to provide a device for securing a baton that meets all of the exigencies of use that may be encountered in police, security or other law enforcement or military activity while avoiding the encumbrances of conventional holders.

It would be advantageous to provide a holder or the like of a type disclosed in the present application that provides any one or more of these or other advantageous features. The present holder further relates to various features and combinations of features shown and described in the disclosed embodiments. Other ways in which the objects and features of the disclosed embodiments are accomplished will be described in the following specification or will become apparent to those skilled in the art after they have read this specification. Such other ways are deemed to fall within the scope of the disclosed embodiments if they fall within the scope of the claims which follow.

### SUMMARY

One embodiment of the present invention relates to a baton holder comprising a holster for removably attaching to a user and configured to receive an extendable baton for storage, the baton having a retracted configuration and an extended configuration. The holster comprises a first retaining flap having a first fastener member that is configured to engage a second fastener member provided on the holster to affix the holster in a first configuration so that a baton may be stored in the holster. The holster comprises a second retaining flap having a third fastener member that is configured to engage a fourth fastener member provided on the holster to affix the holster in the first configuration to hold the baton when provided in the retracted configuration. The third fastener member is configured to disengage the fourth fastener member to provide the holster in a second configuration so that the baton provided in the extended configuration may be stored in the holster.

Another embodiment of the present invention relates to a baton holster comprising a first holder configured to removably attach to a user and to receive a first portion of a baton for storage and a second holder coupled to the first holder and configured to receive a second portion of the baton for storage. The second holder comprises a retaining flap having a first fastener member that is configured to engage a second fastener member provided on the first holder to affix the second holder in a closed position to support the baton when provided on the second holder. The first fastener member of the retaining flap is configured to disengage the second fastener member provided on the first holder to provide the second holder in an open configuration so that a baton may be provided in an extended configuration to extend through the second holder.

Another embodiment of the present invention relates to a method of manufacturing a holster for receiving a baton comprising providing a first holder configured to removably attach to a user and to receive a first portion of a baton for storage, providing a second holder coupled to the first holder and configured to receive a second portion of the baton for storage, configuring the second holder to include a retaining flap having a first fastener member that is configured to engage a second fastener member provided on the first holder to affix the second holder in a closed position to support the baton when provided on the second holder, and configuring the first fastener member of the retaining flap to disengage the second fastener member provided on the first holder to provide the second holder in an open configuration so that a baton may be provided in an extended configuration to extend through the second holder.

### BRIEF DESCRIPTION OF THE DRAWINGS

FIG. 1 is a front perspective view of a baton holster according to an exemplary embodiment.

FIG. 2 is an exploded perspective view of the baton holster of FIG. 1 according to an exemplary embodiment.

FIG. 3 is a side plan view of a baton holster according to an exemplary embodiment.

FIG. 4 is a side plan view of a baton holster according to an exemplary embodiment.

FIG. 5 is a side plan view of a baton holster according to an exemplary embodiment.

FIG. 6 is a front plan view of a baton holster according to an exemplary embodiment.

FIG. 7 is a cross-sectional view of the baton holster of FIG. 1 taken along line 7-7 according to an exemplary embodiment.

FIG. 8 is a front perspective view of a baton holster according to an alternative embodiment.

FIG. 9 is a side plan view of a baton holster according to an alternative embodiment.

### DETAILED DESCRIPTION

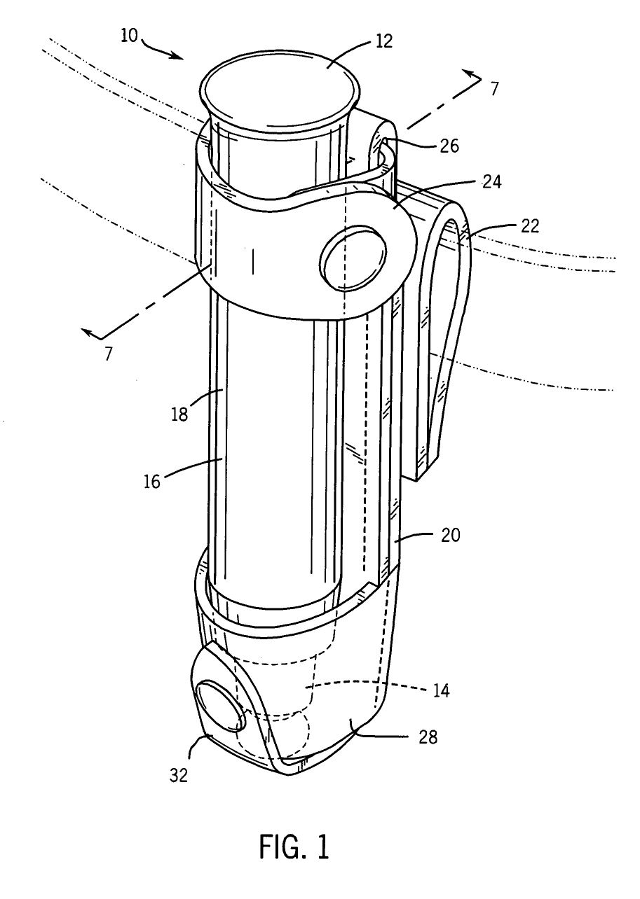

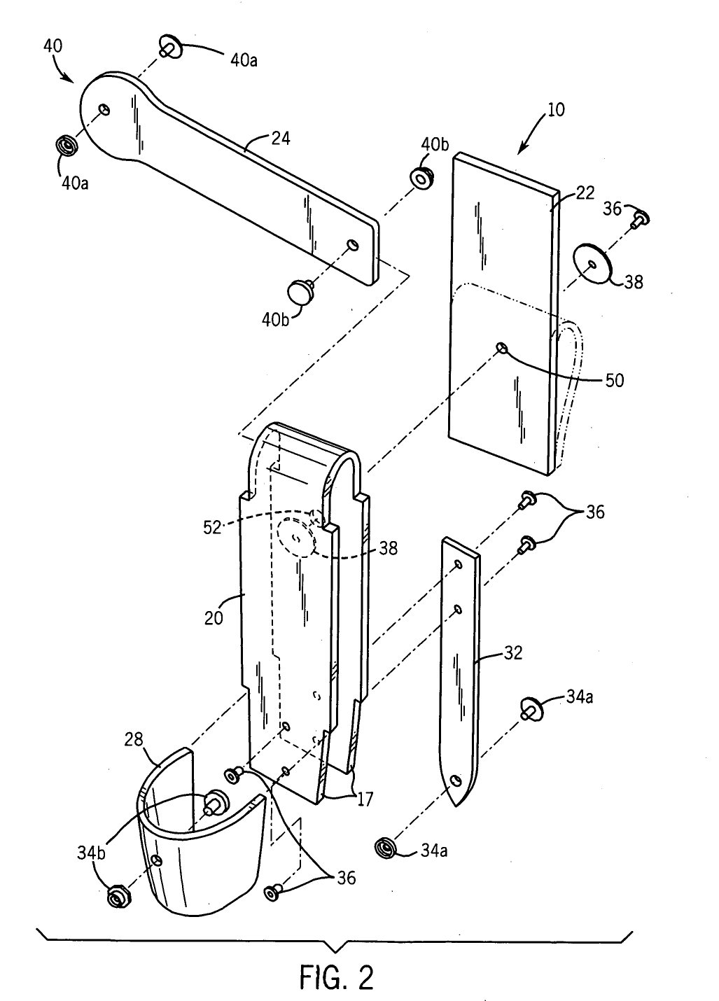

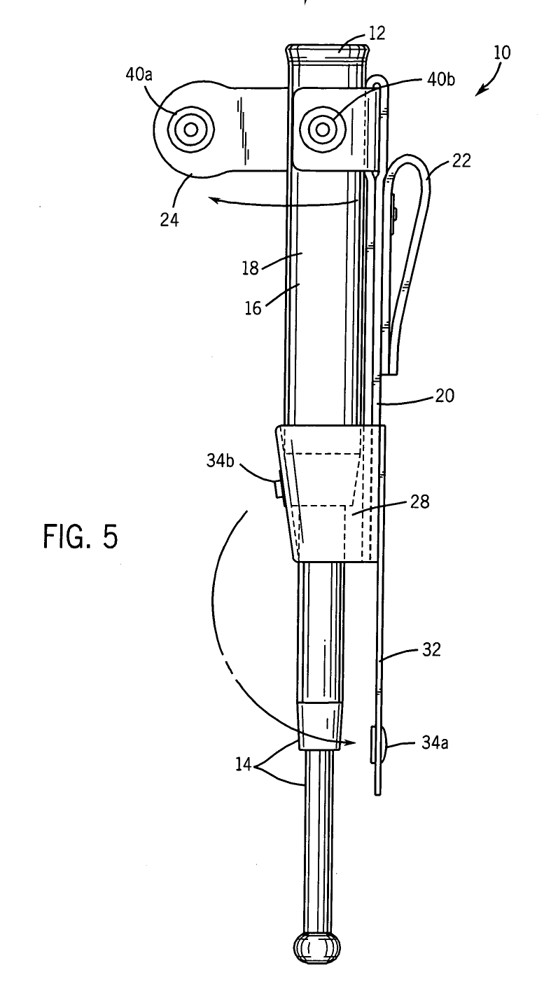

Referring to FIGS. 1 and 2, a baton holster or holder 10 is provided for holding an expandable baton 12. As best shown in FIGS. 1 and 5, expandable baton 12 is of the type comprising a cylindrical outer section which serves as a handle 16. The handle 16 may include a layer of padding material 18 to serve as a grip. One or more telescoping cylindrical sections 14 are nested inside the handle 16 in a retracted position, and are extendable to lock in an extended position.

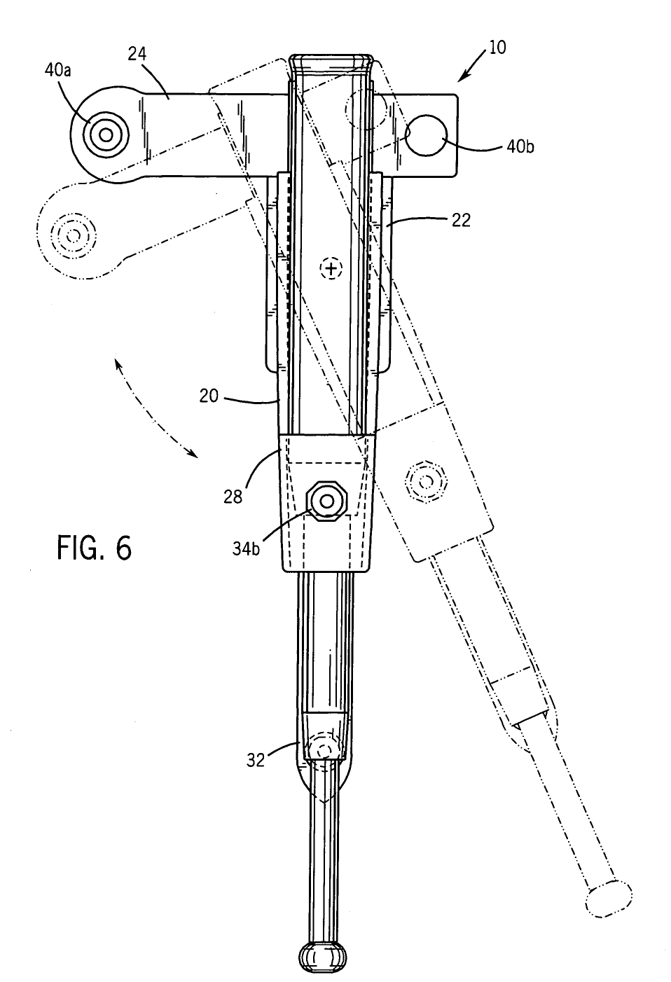

Holder 10 includes a backing, or base 20. As illustrated in FIG. 1, base 20 is formed from a single cut-out piece of material or blank (e.g., leather, nylon, plastic, KYDEX®, etc.) and is folded in half to form an opening or loop 26 near an upper portion of base 20. Base 20 may include a groove (e.g., bend groove) that is configured to allow base 20 to fold (e.g., at a 90 degree angle). The folded base 20 is to coupled together at lower ends 17 with fasteners (e.g., truss head machine screws) to form a double thickness of material. According to an exemplary embodiment, base 20 may include means for attaching to a user (e.g., on a belt). According to an exemplary embodiment, base 20 includes a clip or an attachment strap 22. Attachment strap 22 is rotatably coupled to base 20 with a mating fastener 36 that passes through an opening 50 in attachment strap 22 and opening 52 in base 20, thereby coupling attachment strap 22 to base 20. Washers 38 are provided to allow holder 10 to swivel (e.g., rotate or pivot) around a users belt and/or attachment strap 22 as shown in FIG. 6. Holder 10 may be swiveled to accommodate different positions of a user (e.g., crouching, sitting in a car, etc.). According to alternative embodiments, other suitable means for attaching holsters, accessory cases, and other similar articles to a user may be used (e.g., snaps for directly snapping onto the user's belt, clips, etc.).

According to an exemplary embodiment, an upper retaining flap 24 is attached to the upper end of base 20 by threading flap 24 through an opening or loop 26 formed by base 20. Flap 24 comprises a snap fastener 40. Snap fastener 40 includes a first member 40a and a second member 40b. According to an exemplary embodiment, snap fastener 40 comprises a “hard action” snap socket configuration. An individual in close proximity to a user wearing holder 10 is unlikely to know about the amount of force used to disengage the hard action fastener. Disengaging the “hard action” snap fastener is intended to be difficult and/or time consuming for one who is not accustomed to the motion of snap fastener 40 and who is not wearing holder 10. According to various alternative embodiments, the snap fastener may be a “medium action,” “easy action,” “one directional security snap,” and/or other suitable socket configurations. According to various alternative embodiments, any number of suitable attachment devices may be used for a fastener (e.g., Velcro® brand hook and loop fasteners, clips, etc.).

A lower retaining flap 28 is attached to base 20 along stitch lines 30. According to an exemplary embodiment, the stitching used to attach the blanks together may be of a “French edge stitch” or “corner stitch” configuration. According to various alternative embodiments, any suitable stitching types may be used (e.g., box stitch, corner stitch, 90 degree angle stitch, etc.). A retaining or closure strap 32 is configured to extend from a back portion of base 20, under lower retaining flap 28, and attach to the front of lower retaining flap 28. According to an exemplary embodiment, closure strap 32 couples to the back of base 20 with one or more fasteners 36.

Closure strap 32 is releasably secured to lower retaining flap 28 with a snap fastener 34. Snap fastener 34 includes a first member 34a and a second member 34b. According to an exemplary embodiment, snap fastener 34 comprises a one directional security snap socket configuration, such as that of a PULL-The-DOT® snap fastener available from DOT® Manufacturing Company or LIFT-The-SPOT™ snap fastener available from YKK Snap Fasteners America. A one directional security snap fastener may be cocked, or tilted, in order to engage, disengage or unsnap the two members from each other in a rollover motion, unlike “easy action,” “medium action,” or “hard action” snap fasteners which may be simply pulled apart in no particular orientation. A one directional security snap fastener is intended to remain engaged if a user brushes against another person or object, thereby preventing unintended opening of closure strap 32.

According to an exemplary embodiment, retaining flaps 24, 28 and closure strap 32 are formed of a stiffly resilient, or spring material. According to a particularly preferred embodiment, retaining flaps 24, 28 and closure strap 32 comprise a leather material.

According to an exemplary embodiment, the diameter of upper retaining flap 24 is sized such that with snap 40 fastened, a baton may be inserted or withdrawn axially through the retaining flap 24. According to a particular preferred embodiment, a snug fit is formed between the handle and retaining flap 24 to hold a baton firmly (e.g., to restrain lateral movement, yet permit axial movement). Any padding on the handle of the baton is typically somewhat deformable to allow movement within flap 24 while at the same time maintaining the snug fit.

According to an exemplary embodiment, lower retaining flap 28 is provided in an at least partially conical shape (e.g., tapering from a larger diameter top opening to a smaller diameter bottom opening). The larger diameter of the conical section faces upwards, towards the upper retaining flap 24, and is approximately the same diameter as that of the upper retaining flap 24. The smaller diameter portion of retaining flap 28 is configured to allow at least a portion of the baton to pass through (e.g., telescoping portions) when closure strap 32 is not fastened to retaining flap 28. The smaller diameter portion of retaining flap 28 is configured to prevent the entire baton from passing through (e.g., the diameter is smaller than a portion of the baton). In that way, downward axial movement of the baton is at least partially resisted by lower retaining flap 28, while the telescoping portions, if extended, are allowed to pass through the flap 28. To avoid unintentional release of the telescoping portions of the baton when provided in holder 10, closure strap 32 may be fastened to flap 28. Strap 32 is configured to provide support to the baton and be releasable from flap 28 so that telescoping portions of the baton may extend through flap 28 after use (e.g., when a user is done using the extended baton but is unable to retract it at that time).

In operation, the handle of the baton may be inserted through the upper retaining flap 24 until contact is made between the lower retracted end portion of the handle and closure strap 32 fastened to lower flap 28. At that point, further downward axial movement is resisted, and the baton is held secure at at least two points (e.g., both the upper and lower retaining flaps 24 and 28). According to an exemplary embodiment, axial movement is accommodated when fastener 40 is fastened (e.g., to withdraw the baton axially). According to an exemplary embodiment, with the snap fastener 40 released, the baton may also be withdrawn laterally, or “broken out” to the side of the holder 10.

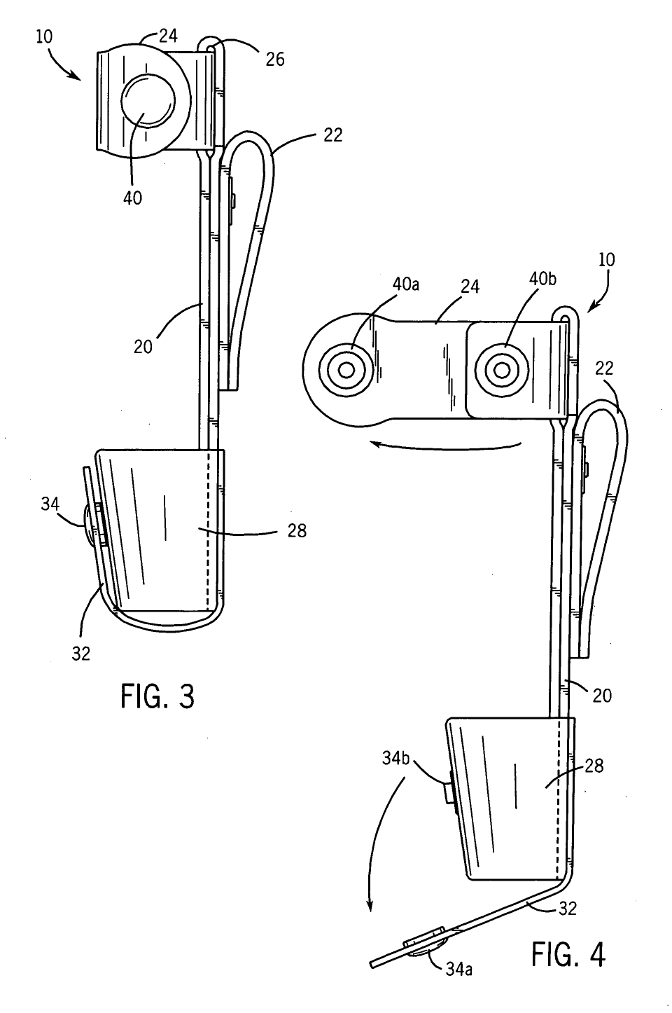

Referring to FIG. 3, upper retaining flap 24 and closure strap 32 are fastened so that a baton may be stored in holder 10. Flap 24 is curved to fit around a baton handle so that member 40a of fastener 40 engages member 40b. Member 34a is engaged with member 34b so that fastener 34 couples strap 32 to lower retaining flap 28 to support a baton within flap 28.

As shown in FIG. 4, fastener 40 is shown after being disengaged so that upper retaining flap 24 is in an open position. Snap fastener 34 is shown disconnected as member 34a has been moved away from member 34b. Referring to FIGS. 5 and 6, a baton in an extended configuration is shown positioned in holder 10. Upper retaining flap 24 is provided in an open position so that a user may grip the baton handle to remove the baton from holder 10. Closure strap 32 is provided in an open position so that a baton in an extended configuration can be placed in holder 10 (e.g., after using the baton and subduing an individual). A user may place the baton in holder 10 instead of laying the baton down, as it could then be kicked away, grabbed by another party, or roll away. According to an exemplary embodiment, the extended baton is inserted axially, down through retaining flap 24. Because lower retaining flap 28 is intended to have a larger diameter than that of the telescoping sections of the baton, the telescoping sections are able to pass through lower retaining flap 28 freely. However, the handle of the baton, having a diameter greater than the smaller opening in lower retaining flap 28, eventually contacts with lower retaining flap 28, and further downward axial movement is resisted.

According to an exemplary embodiment, the insertion of the baton (extended or not) can be accomplished with retaining flap 24 fastened. The ability to accommodate an extended baton can arise from many different circumstances. For example, extendable batons can utilize “dead lock taper” joints to hold the baton extended. To retract the telescoping sections, it is necessary to strike a sharp axial blow with the tip of the innermost telescoping section on a hard surface, such as concrete. Depending upon the environment in which the baton is deployed, a suitable surface for closing the baton may not be available, and the baton may need to be carried temporarily in the extended position. For example, in the case of law enforcement officers acting on private property (e.g., in the case of boarding boats at sea), the officers may be precluded from striking the baton on the private property as it could cause damage.

According to an exemplary embodiment, base 20, attachment strap 22, upper retaining flap 24, lower retaining flap 28 and closure strap 32 are made of a sheet of 0.100 inch to 0.220 inch thick leather material (e.g., 4 to 12 ounce leather). According to various exemplary embodiments, any of the parts and/or components (e.g., the blanks, straps, flaps, etc.) of the holster may be manufactured from leather, synthetic leather, KYDEX®, canvas, nylon, and/or any other suitable material in any suitable amount. According to an exemplary embodiment, KYDEX® can be formed to a desired shape using thermo-setting methods.

According to various exemplary embodiments, the holder may be configured to attach to a user at any suitable location (e.g., leg shroud or strap, ankle strap, belt line, shoulder strap, etc.). As shown in the FIGURES, flaps 24 and 28 are intended to protect the baton. Flaps 24 and 28 are not intended to take the exact form of the batons and are shaped to protect and support the baton.

The numerous fasteners described in this system are, in general, self-locking machine screws and tee nuts. The heads of the machine screws are provided a low silhouette (e.g., truss head or oval head with a finishing washer). Tee nuts are fastening devices having thin, substantially circular heads with small barbs extending therefrom to prevent rotation, and internally threaded bodies extending therefrom to receive the screws. The self-locking feature may be implemented in any of the conventional ways known to those of skill in the art (e.g., polymer plug, polymer patch, anaerobically curing thread-locking compound, elliptical or other deformation of threads, etc.).

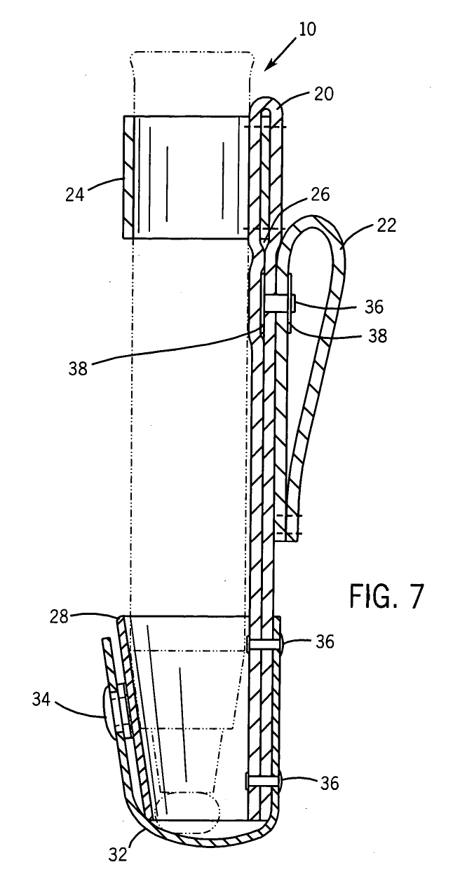

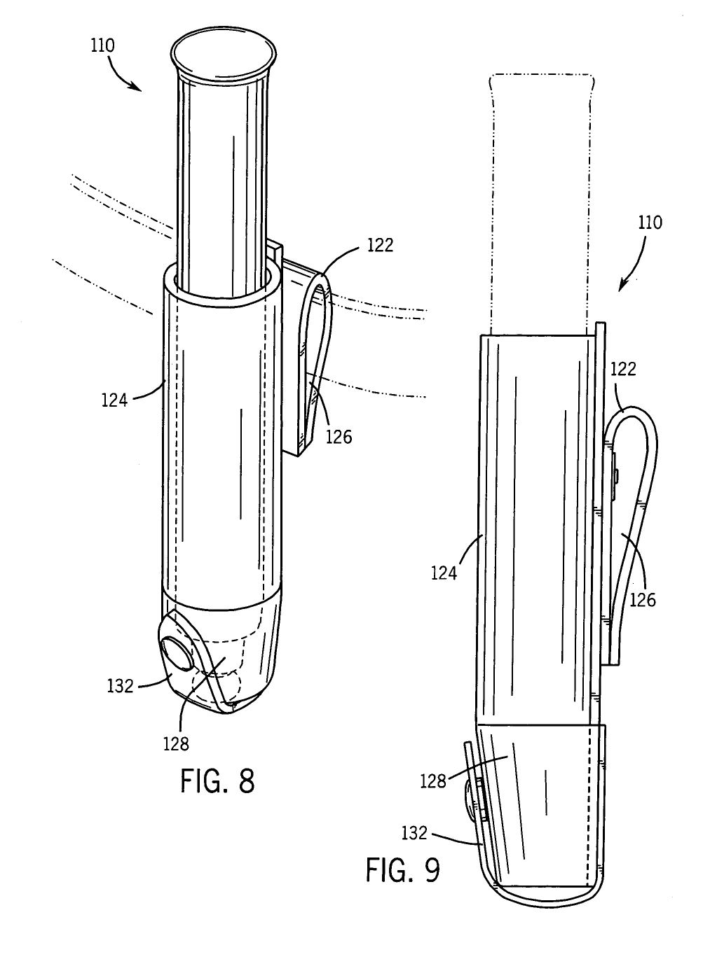

A holder 110 is shown according to an alternative embodiment in FIGS. 8 and 9. Holder 110 includes an attachment strap 122, an opening or loop 126, a lower retaining flap 128 and a closure strap 132. Holder 110 includes a body 124 for supporting a baton. Body 124 does not include a snap or other fastening device for removing the baton from holder 110. Instead, body 124 is configured to allow a baton to be removed from body 124 and holder 110 with suitable force. Closure strap 132 may be provided in an open position as described in conjunction with closure strap 32 shown in FIGS. 1-7 to allow telescoping portions of a baton provided in an extended configuration to pass through lower retaining flap 128. According to an exemplary embodiment, holder 110 and its components may be formed from the same or similar materials as those described above in conjunction with holder 10 shown in FIGS. 1-7.

It is important to note that the above-described embodiments are illustrative only. Although the holders have been described in conjunction with specific embodiments thereof, those skilled in the art will appreciate that numerous modifications are possible without materially departing from the novel teachings and advantages of the subject matter described herein. For example, different types of devices (e.g., any suitable batons) and assemblies may be used in addition to or instead of the those described herein. Accordingly, these and all other such modifications are intended to be included within the scope of the appended claims. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating conditions and arrangements of the preferred and other exemplary embodiments without departing from the scope of the appended claims.

What is claimed is:

1. A baton holder comprising:
a holster for removably attaching to a user and configured to receive an extendable baton for storage, the baton having a retracted configuration and an extended configuration;
wherein the holster comprises a first retaining flap having a first fastener member that is configured to engage a second fastener member provided on the holster to affix the holster in a first configuration so that a baton may be stored in the holster; and
wherein the holster comprises a second retaining flap having a third fastener member that is configured to engage a fourth fastener member provided on the holster to affix the holster in the first configuration to hold the baton when provided in the retracted configuration; and
wherein the third fastener member is configured to disengage the fourth fastener member to provide the holster in a second configuration so that the baton provided in the extended configuration may be stored in the holster.

2. The baton holder of claim 1, further comprising an attachment device configured to couple the holster to a user.

3. The baton holder of claim 2, wherein the attachment device is a clip.

4. The baton holder of claim 2, wherein the attachment device is a belt loop.

5. The baton holder of claim 2, wherein the holster comprises a pivot coupled to the holster and belt attachment and configured to allow the holster to pivot between a first position and a second position.

6. The holster of claim 1, wherein the first configuration comprises a closed position.

7. The holster of claim 1, wherein the second configuration comprises an open position.

8. The holster of claim 1, wherein the first and second holders comprise leather.

9. The holster of claim 1, wherein the second fastener member is a one directional snap fastener.

10. A baton holster comprising:
a first holder configured to removably attach to a user and to receive a first portion of a baton for storage; and
a second holder coupled to the first holder and configured to receive a second portion of the baton for storage;
wherein the second holder comprises a retaining flap having a first fastener member that is configured to engage a second fastener member provided on the first holder to affix the second holder in a closed position to support the baton when provided on the second holder; and
wherein the first fastener member of the retaining flap is configured to disengage the second fastener member provided on the first holder to provide the second holder in an open configuration so that a baton may be provided in an extended configuration to extend through the second holder.

11. The holster of claim 10, further comprising an attaching device provided on a rear side of the first holder for attaching the first holder to the user.

12. The holster of claim 11, further comprising a pivot coupled to the first holder and the attaching device and configured to allow the holster to pivot between a first position and a second position.

13. The holster of claim 10, wherein the first and second holders comprise leather.

14. The holster of claim 10, wherein the first holder comprises a retaining flap for retaining a baton in the first holder, wherein the retaining flap comprises a third fastener member configured to engage a fourth fastener member affixed to a thumb break.

15. The holster of claim 10, wherein the first and second fastener members comprise a one directional snap fastener.

16. A method of manufacturing a holster for receiving a baton comprising:
providing a first holder configured to removably attach to a user and to receive a first portion of a baton for storage; and
providing a second holder coupled to the first holder and configured to receive a second portion of the baton for storage;
configuring the second holder to include a retaining flap having a first fastener member that is configured to engage a second fastener member provided on the first holder to affix the second holder in a closed position to support the baton when provided on the second holder; and
configuring the first fastener member of the retaining flap to disengage the second fastener member provided on the first holder to provide the second holder in an open configuration so that a baton may be provided in an extended configuration to extend through the second holder.

17. The method of claim 16, wherein the first and second holders comprise leather.

18. The method of claim 16, further comprising providing an attaching device provided on a rear side of the first holder for attaching the first holder to the user.

19. The method of claim 18, further comprising providing a pivot coupled to the first holder and the attaching device and configured to allow the holster to pivot between a first position and a second position.

20. The method of claim 16, wherein the first and second fastener members comprise a one directional snap fastener.
